(19) United States
(12) Patent Application Publication
(10) Pub. No.: US 2013/0213530 A1
(43) Pub. Date: Aug. 22, 2013

(54) Process for Conditioning the Surface of Hardened Sheet-Steel Components Which Are Protected Against Corrosion

(71) Applicants: Martin Rosner, Oed-Ohling (AT); Gregor Diesenreiter, Weitersfelden (AT); Gerald Luckeneder, Pinsdorf (AT); Robert Autengruber, Linz (AT)

(72) Inventors: Martin Rosner, Oed-Ohling (AT); Gregor Diesenreiter, Weitersfelden (AT); Gerald Luckeneder, Pinsdorf (AT); Robert Autengruber, Linz (AT)

(73) Assignee: VOESTALPINE STAHL GMBH, Linz (AT)

(21) Appl. No.: 13/817,228

(22) PCT Filed: Jun. 6, 2011
(86) PCT No.: PCT/EP2011/059272

§ 371 Date: Apr. 29, 2013

(30) Foreign Application Priority Data
Aug. 19, 2010 (DE) 102010037077.0-45

(51) Int. Cl. B05D 3/12; B05D 3/02

(52) U.S. Cl. CPC B05D 3/12; B05D 3/0254
USPC 148/534

(57) ABSTRACT

The invention relates to a process for conditioning the surface of hardened, corrosion-protected sheet-steel components; the steel plate is a steel plate that is covered with a metallic coating and is heated for hardening and is then quench hardened and after the hardening, oxides that are present on the corrosion protection coating due to the heating are removed; the component undergoes a slide grinding in order to condition the surface of the metallic covering or corrosion protection layer.

### FIELD OF THE INVENTION

The invention relates to a process for conditioning the surface of hardened, corrosion-protected sheet-steel components.

### BACKGROUND OF THE INVENTION

It is known to provide steel components with a corrosion protection layer in order to prevent corrosion of the steel material.

It is also known to embody such corrosion protection layers out of a base metal so that the base metal constitutes a so-called cathodic corrosion protection.

The applicant's WO 2005/021822 has disclosed, in order to protect a cathodic corrosion protection layer, adding oxygen-affine elements, within certain limits, to the base metal constituting the cathodic corrosion protection layer in order to provide a protection of the cathodic protection layer in high temperature processes for the quench hardening of the material. In order to harden components of this kind, they must be heated to a temperature above the austenitizing temperature of the base metal, in this case steel. Particularly with high hardenability steels, this temperature is greater than 800° C. At such temperatures, most cathodic protection layers are destroyed by vaporization or oxidation so that a component treated in this way would not have any cathodic protection after the hardening. The addition of oxygen-affine elements results in the fact that the oxygen-affine elements diffuse out of the composition of the cathodic protection layer to the surface and form a very thin protective layer there. This very thin protective layer can, for example, be composed of magnesium oxide or aluminum oxide or mixtures thereof. WO 2005/021822 has also disclosed the use of such a process in roll forming

EP 1 561 542 A1 has disclosed a process for removing a layer of a component. In this case, this is a layer composed of an organic binder, which is to be removed from a substrate without damaging the substrate. To this end, a jet of dry ice particles is guided across the surface so that the action of the dry ice particles blasts material away from the layer that contains an organic binder. The dry ice removal is intended to prevent a contamination with foreign substances and the metallic base body of the component is not harmed.

EP 1 321 625 B1 has disclosed a process for removing a metal layer; it includes a layer system with the metal layer and a substrate coated with the metal layer, and the removal process is a blasting process. The blasting process in this case can be a sandblasting process in which the metal layer is powerfully cooled in order to achieve a low temperature embrittlement of the layer relative to the substrate.

EP 1 034 890 A2 has disclosed a process and device for blasting with various blasting abrasives. The intent of the reference is to disclose an abrasive blasting treatment with blasting abrasives in which the abrasive action of the blasting abrasives lies between that of blasting abrasives that are liquid under normal conditions and that of blasting abrasives that are in a solid physical state under normal conditions. In this case, a mixture composed of a first blasting abrasive such as dry ice and a second blasting abrasive such as sand is used.

DE 199 46 975 C1 has disclosed a device and process for removing a coating from a substrate, which is intended to be gentle on materials and suitable for removing both soft and hard coatings. In this case, a cold treatment is carried out by blasting with a refrigerant, which results in an embrittlement of the coating, and then an abrasive cleaning action is carried out with a machining tool; the cold treatment permits the mechanical abrasive treatment to be embodied with tool parts that are not as hard as in machining tools according to the prior art.

DE 199 42 785 A1 has disclosed a process for removing solid machining residues, surface coatings, or oxide layers in which a cleaning should occur only in places in which solid machining residues are present. In this case, the cleaning can be carried out with steam blasting or dry ice blasting or can be carried out with technically induced shock waves, so-called laser cleaners. CO₂ cleaning can be carried out with intrinsically known dry ice pellets.

DE 102 43 035 B4 has disclosed a device and process for removing layers that form on metal components due to heating and cooling. When removing for example cinders, oxide silicate, and slag layers on metal workpieces and in particular on metal workpieces with uneven surfaces such as axle and body components of vehicles, because the solid particles cannot be completely removed from metal workpieces in every case when abrasive compressed gas blasting is used, the compressed gas flow that is used to project, for example, dry ice particles at the metal workpiece to be cleaned should be preheated and should have a temperature that is greater than the temperature of the air surrounding the metal workpiece and/or than the surface temperature of the metal workpiece. This should result in the fact that on the one hand, the metal workpiece is not cooled down too much and on the other hand, the compressed gas is essentially free of moisture, thus avoiding an undesirable buildup of condensation. The layers to be removed from the surface of the metal component are blasted away by the mechanical action of the dry ice particles, which have a high-speed impact and therefore exert an abrasive action, and by the locally limited cooling of the surface and layer caused by the dry ice particles.

DE 10 2007 022 174 B3 has disclosed a process for producing and removing a temporary protective layer for a cathodic coating, particular in order to produce a hardened steel component with an easily paintable surface. The very thin protective layer of aluminum and/or magnesium oxide, which forms in this process and is also known from WO 2005/021822, has cracks and/or defects in this layer. These cracks make it possible to use a dry ice blasting process to detach flakes of the oxide bordering the cracks and/or defects. This blasting is carried out with dry ice only, with no additives; the dry ice particles penetrate through the cracks and/or defects into the cavities under the protective layer and sublimate, experiencing a volume increase of up to 800 times. This blasts away any loose or to-be-loosened particles of the oxide of the oxygen-affine element(s) along with any zinc oxide particles that may be present thereon. The additional thermal shock due to the extremely cold dry ice particles results in further thermal stresses in the layer composed of the oxide of the oxygen-affine element(s) and thus promotes the desired removal. This should permit omission of an abrasive removal.

The object of the invention is to condition the surface of hardened sheet-steel components provided with a corrosion protection layer after a temperature treatment for hardening and to improve paint adhesion and weldability.

### SUMMARY OF THE INVENTION

According to the invention, the surface conditioning is carried out in that in lieu of a sandblasting or dry ice blasting process, a so-called slide grinding is carried out. Slide grinding processes are fundamentally known and are described, for example, in the following published documents:
KR 1020000059342 A (Hankook Tire)
WO 02/055263 (REM Chemicals)
WO 98/15383 (Terschluse)
EP 0 103 848 A2 (Heilberger, Heilberger)
EP 1 857 224 A1 (Rösler)
EP 0 324 394 A2 (Henkel)
DE 44 04 123 C1 (Dreher)

The term slide grinding is understood to mean a separating process, in particular for surface-treating metallic workpieces. The workpieces to be machined are placed in a container together with abrasive particles and possibly an additive, particularly in an aqueous solution. In this container, a relative movement is produced between the workpiece and the abrasive particles, thus producing a removal of material on the workpiece. This relative movement is in particular caused by an oscillating or rotating movement of the working container.

Slide grinding is recorded in the German standard DIN 8589 and is referred to therein as slide machining since not only a grinding process, but also a lapping or polishing can take place, depending on the process.

Working containers in the form of steel drums and also elongated vibration troughs are used, which can be optionally clad with plastic for sound insulation and abrasion protection. Abrasive media in the form of abrasive particles of between 1 mm and 80 mm in size are used, which can be of different shapes. The content of abrasive or polishing minerals or media determines the aggressiveness and wear as well as the achievable surface smoothness of the workpiece. These can be conventional abrasive particles composed of ceramic, plastic, or natural materials. The additives serve to entrain the wear debris and transport it away. In addition, the additives can contain substances for corrosion protection and degreasing.

Slide grinding is usually a discontinuous process in which a load of parts and abrasive particles are introduced into the slide grinding container and the workpieces are removed after the end of the machining

In particular, the various slide grinding processes are distinguished by means of their container.

In barrel finishing, a horizontally arranged or inclined container is rotated around its longitudinal axis. The rotation speed of the barrel has a decisive influence on the material removal rate and the surface quality achieved. However, the rotation speed can only be increased up to a certain point.

In vibratory finishing, large vibrators set the entire contents of the container into vibration, thus making it also possible to machine heavy and large workpieces, which in barrel finishing and centrifugal finishing, remain at the bottom or get caught on or strike against one another in the container. The contents move in a horizontal helix. The design of the machine is either pot-shaped for one-time filling or helical for continuous processes.

In immersion finishing, individual workpieces or a plurality of workpieces is/are simultaneously secured by a holder and held in the flowing abrasive compound.

Centrifugal finishing chiefly involves two variants: planetary centrifugal machining uses a rotor with a plurality of barrels arranged around its circumference and the centrifugal forces generated in the barrels can reach up to 15 times the normal force of gravity, which results in a significant savings in processing time by comparison with barrel machining But this machining method cannot be used for unstable and hollow workpieces. In centrifugal disc machining, the mixture is contained in a stationary, pot-shaped container whose concave plastic bottom rotates. Arc-shaped radially oriented ribs on the bottom entrain the mixture along with them and it rises up the container wall and then, pushed by the replenishing flow that comes after it, slides back to the middle again. The advantages include a reduced working time compared to barrel finishing.

In a so-called flow finisher, a stable belt on the inside continuously rotates the parts and the abrasive particles.

Particularly suitable for use with the invention is an elongated vibration trough in which both the slide grinding product and the slide grinding particles are conveyed along the longitudinal span in vibrating fashion, are separated after passing through, the slide grinding medium is recirculated, and the machined pieces are machined again.

### BRIEF DESCRIPTION OF THE DRAWINGS

The invention will be explained by way of example in conjunction with the drawings. In the drawings:

FIG. 1: shows a cross-section through an untreated surface; on the FeZn layer, an oxide layer (black) up to 5 μm thick is visible;

FIG. 2: shows a transverse section through the surface after 10 min of slide grinding treatment; the FeZn surface is smoothed and the oxides have been almost completely removed;

FIG. 3: shows the surface according to FIG. 1 in a top view after the annealing of the zinc layer (910° C., 4 min);

FIG. 4: shows the surface according to FIG. 3 after 10 min of slide grinding treatment;

FIG. 5: shows the electron microscopic image of micro-pores on the ground surface according to FIG. 4;

FIG. 6: shows the comparison of the different surfaces;

FIG. 7: shows the composition of the steel grades used;

FIG. 8: shows steel grades that are suitable for the process, with an indication of the composition in wt. % (weight percent).

### DETAILED DESCRIPTION OF THE PREFERRED EMBODIMENTS

The invention will be described in conjunction with an experiment.

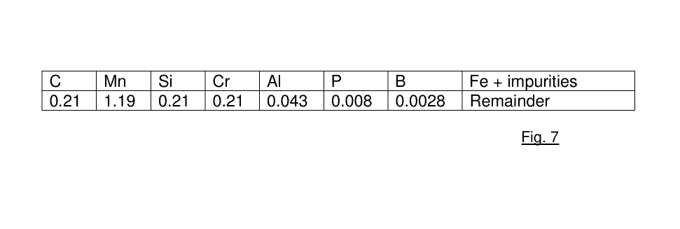

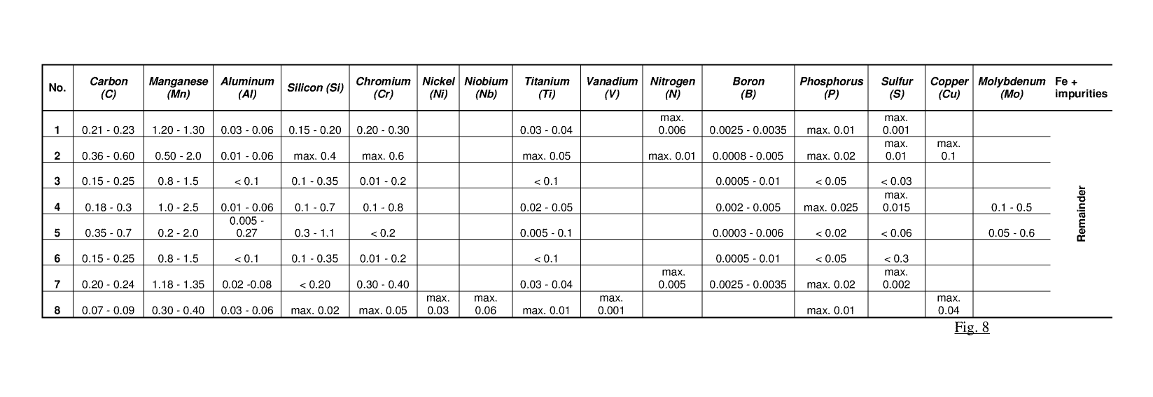

A heat-treatable steel with the chemical composition indicated in FIG. 7 was used. The surface was hot-dip refined with zinc. The Zn layer thickness was 140 g/m² (on both sides). A specimen with the dimensions 200 mm×300 mm and with a sheet thickness of 1 mm was annealed for four minutes at 910° C. in a laboratory furnace. The specimen was hardened between two water-cooled steel plates.

This hardened plate was divided into 4 sections 100 mm×150 mm; three of these were subjected to a slide grinding cleaning for two, five, and ten minutes. One section was retained as a reference. The slide grinding took place in a horizontal centrifugal force barrel with a diameter of 700 mm The barrel was filled with elliptical abrasive particles (15 mm×15 mm×5 mm) made of ceramic and with a liquid compound composed of organic acids, alcohols, and tensides. After the treatment phase, the specimens were removed from the barrel and dried with compressed air.

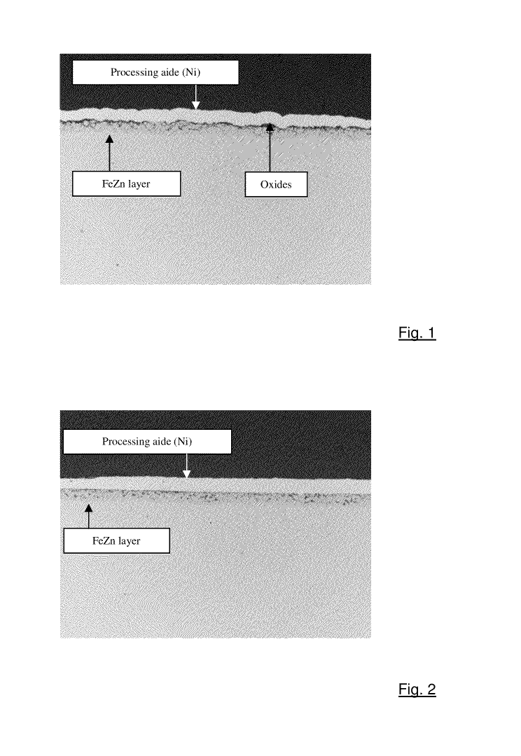

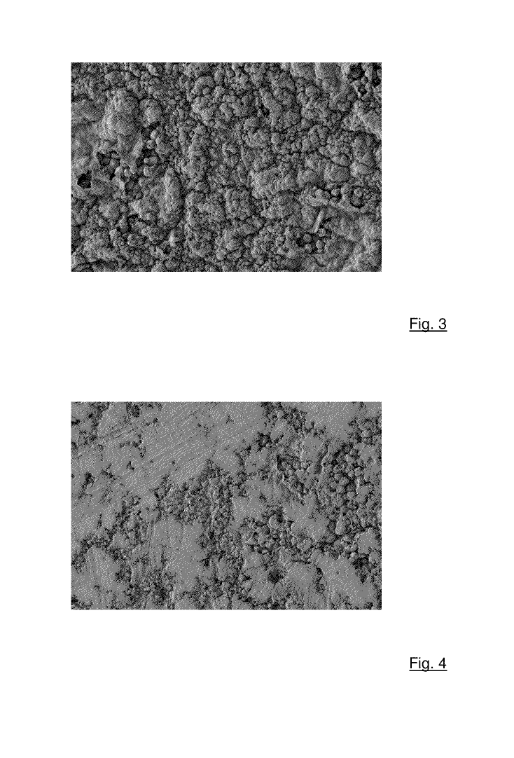

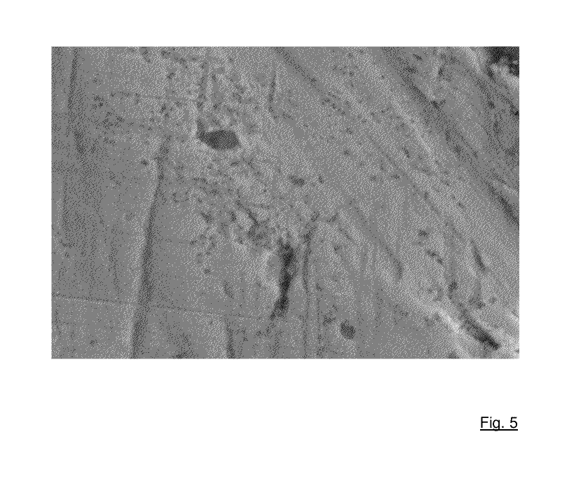

The FeZnMn oxides produced by the annealing process (FIG. 1, FIG. 3) were removed from the surface, and the zinc ferrite layer was exposed and evened out (FIG. 2, FIG. 4). At the same time, a temporary corrosion protection was applied by adding suitable additives to the liquid compound in the grinding barrel (or trough).

Since the surface is virtually oxide-free, it has outstanding weldability. By measuring the surface transfer resistance (according to the data sheet DVS2929-1), it is possible to test the spot weldability of the material. The measurement values of a surface cleaned by slide grinding are approx. 0.2 mOhm/m and lower, while an untreated surface typically has measurement values of around 10 mOhm/m. With such high surface transfer resistances, spot welding cannot be carried out. Values below 1.5 mOhm/m would be ideal.

According to theory, a particularly smooth surface is not a good base surface for paints or adhesives. In the material used, with the above-mentioned coating, nano-porosities were unexpectedly exposed on the microscopically smoothed metallic FeZn phases (FIG. 5), which only became visible when magnified 100,000 times in the electron microscope. They have a size of between 10 and 100 nm These nanopores increase the surface area and thus significantly improve the adhesion of a paint or adhesive.

### Comparison to Other Cleaning Methods

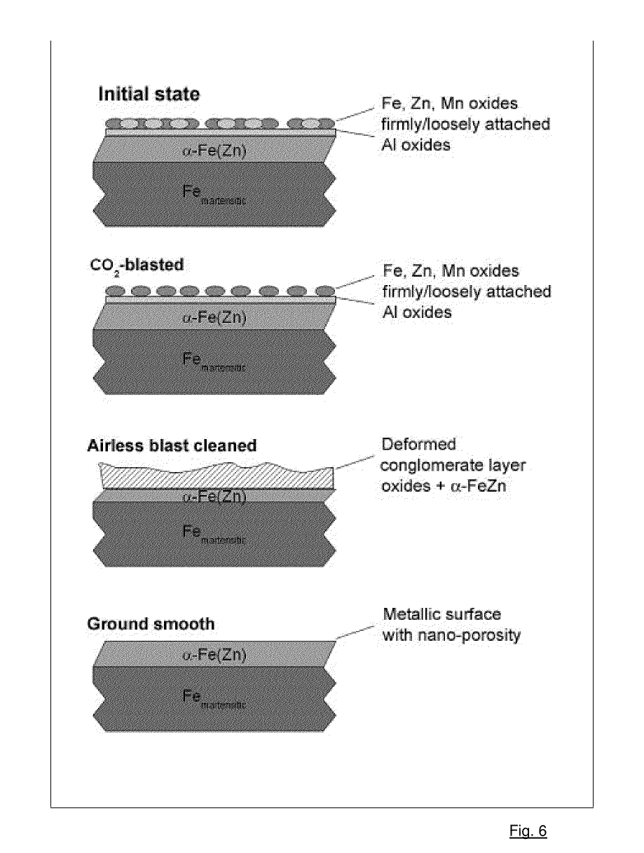

After the annealing of the sample material, mixed oxides composed of Fe, Zn, and Mn (alloying element in the steel) are present on the surface. Some of these oxides are firmly attached, some are loosely attached. Aluminum oxides originate from the Al (>1%) alloyed in the Zn bath. Underneath the oxides is a FeZn diffusion layer approx. 25 μm thick (FIG. 6).

Dry ice blasting (CO₂) removes only the loosely attached oxides from the surface (FIG. 6). Another conventional cleaning process is airless blast cleaning in which the surface is blasted with steel shot that is accelerated in a shot-blasting wheel. This is not a cleaning, strictly speaking, since the oxides are not removed from the surface, but rather are pressed into the FeZn diffusion layer by the high impact speed of the steel shot. This produces a conglomerate layer, which, depending on the impact angle of the blasting medium, also cannot be cropped.

The slide grinding used according to the invention efficiently removes the oxides produced in the annealing and exposes the underlying metal. The surface is smoothed at the same time. Exposed nanoporosities improve the adhesion of a paint or adhesive. Since the surface is oxide free, this ensures weldability.

The application of the temporary corrosion protection as an additional functionality of the liquid compound that is required for the slide grinding process eliminates the need for subsequently re-oiling the surface (avoid oil spray mist, worker protection).

### Application Example

### 1. Slide Grinding of a Press-Hardened Component for Automotive Applications

A reinforcing component of a B-pillar (approx. 1200 mm×500 mm, sheet thickness 1.8 mm) was cleaned for 5 min in a trough vibrator.

The trough size was approx. 1500 m×800 m, the treatment time lasted 5 minutes. Elliptical abrasive particles and a liquid compound with temporary corrosion protection, both as described above.

After the slide grinding treatment, the component's metallographic section has the typical oxide removal and smoothing of the surface. Paint adhesion tests were carried out. Samples from the cleaned component were phosphate-treated, coated by cataphoretic painting, scratched, and corrosively aged for 10 weeks in accordance with VDA621-415. The paint infiltrated 0 mm into the scratch. In addition, a cross-cut test was carried out before and after the corrosive aging. Both tests yielded a score of GT0 (best result). The weldability was determined by measuring the surface transfer resistance according to DVS2929-1. An untreated surface typically has approx. 10 mOhm/m. After the cleaning, the surface transfer resistance was less than 0.2 mOhm/m.

The component can also be cleaned, achieving the same cleaning result, in a continuous-flow trough vibrator that can, for example, be 6 m long. This makes it possible to clean larger production runs of the kind that come up in industrial component production.

### 2. Reinforcing Component in Centrifugal Force Barrel

A component (reinforcing component, strut) with dimensions of approx. 300 Mm×approx. 100 mm can be cleaned in a centrifugal force barrel with a diameter of 700 mm using the same compound and the same abrasive particles cited in example 1. A treatment time of 5 minutes was selected. The component treated in this way demonstrated both outstanding paint adhesion and outstanding weldability.

1. A process for conditioning the surface of hardened, corrosion-protected sheet-steel components, comprising:
covering a steel plate with a metallic coating;
heating the steel plate for hardening and then quench hardening;
after the hardening, removing oxides that are present on the corrosion protection coating due to the heating; and
slide grinding the steel plate in order to condition the surface of the metallic covering or corrosion protection layer.

2. The process as recited in claim 1, wherein the corrosion protection layer is a zinc-based coating; during the heating and quench hardening, ZnFe phases form in the corrosion protection layer; and further comprising carrying out the surface conditioning so that oxides resting on or adhering to the corrosion protection layer are ground off and ZnFe phases that are present in the corrosion protection layer are ground away slightly and their micro-porosity is exposed.

3. The process as recited in claim 2, wherein at least one of the group consisting of a duration of the slide grinding, a vibration amplitude of the slide grinding, and slide grinding particles are matched so that, the oxides are ground off and the ZnFe phases are ground away slightly, but the corrosion protection coating is essentially not ground off.

4. The process according to claim 1, further comprising using slide grinding particles and solid and/or liquid additives during the slide grinding; wherein the solid and/or liquid additives bind to and transport away the wear debris and/or additives are present that in addition to the surface conditioning, coat the surface in a corrosion-inhibiting way.

5. The process according to claim 1, wherein the slide grinding particles have a liquid compound added to them, which comprises at least one of the group consisting of organic acids, alcohols, tensides, and waxes.

6. The process according to claim 1, comprising using a steel with the following composition in weight percent for the steel material:
Element Content in wt. %
C=0.07-0.7
Mn=0.2-2.5
Al=0.005-0.27
Si=0.1-1.1
Cr=0.01-0.8
Ni=0.001-0.03
Nb=up to 0.06
Ti=0.005-0.1
V=up to 0.001
N=up to 0.01
B=0.0003-0.01
P=up to 0.05
S=up to 0.3
Cu=up to 0.1
Mo=0.05-0.6
remainder=Fe and impurities
